(19) United States
(12) Patent Application Publication
(10) Pub. No.: US 2019/0071069 A1
(43) Pub. Date: Mar. 7, 2019

(54) METHOD AND DEVICE FOR REDUCING A RISK OF A COLLISION OF A MOTOR VEHICLE WITH AN OBJECT

(71) Applicant: Robert Bosch GmbH, Stuttgart (DE)

(72) Inventor: Stefan Nordbruch, Kornwestheim (DE)

(21) Appl. No.: 15/767,218

(22) PCT Filed: Sep. 20, 2016
(86) PCT No.: PCT/EP2016/072275

§ 371 Date: Apr. 10, 2018

(30) Foreign Application Priority Data
Oct. 22, 2015 (DE) 102015220646.7

(51) Int. Cl. B60W 30/06; B60W 30/09; B60W 30/095; B60W 50/00; B62D 15/02; G08G 1/16

(52) U.S. Cl. CPC B60W 30/06; B60W 30/09; B60W 30/0956; B60W 50/0097; B62D 15/0285; B60W 2720/10; G08G 1/168; B60W 2520/10; B60W 2550/10; B60W 2550/404; B60W 2710/182; G08G 1/165

(57) ABSTRACT

A method for reducing a risk of a collision of a driving motor vehicle with an object, including determining a first safety area, which defines a first delimited subarea of a current surroundings of the driving motor vehicle, determining a second safety area, which defines a second delimited subarea of the current surroundings of the driving motor vehicle, the second subarea being at a greater distance from the motor vehicle than the first subarea, monitoring the first and second subareas for an object moving into the respective safety area and/or for an object located within the respective safety area, controlling a stoppage of the motor vehicle if the monitoring has determined that an object is located within the first safety area, to stop the motor vehicle, and controlling a performance of one or several safety actions if the monitoring determines that an object is located within the second safety area.

### FIELD

The present invention relates to a method and a device for reducing a risk of a collision of a motor vehicle with an object. Furthermore, the present invention relates to a motor vehicle, to a parking facility and to a computer program.

### BACKGROUND INFORMATION

German Patent Application No. DE 10 2012 222 562 A1 describes a system for managed parking areas for transferring a vehicle from a starting position to a destination position.

During such a transfer, it is important that the vehicle does not collide with objects, for example persons or other vehicles.

### SUMMARY

An object of the present invention is to provide for the efficient reduction of a risk of a collision of a motor vehicle with an object.

Advantageous developments of the present invention are described herein.

According to one aspect of the present invention, a method is provided for reducing a risk of a collision of a driving motor vehicle with an object, including the following steps:
determining a first safety area, which defines a first delimited subarea of a current surroundings of the driving motor vehicle,
determining a second safety area, which defines a second delimited subarea of the current surroundings of the driving motor vehicle, the second subarea being at a greater distance from the motor vehicle than the first subarea,
monitoring the first and the second subareas for an object moving into the respective safety area and/or for an object located within the respective safety area,
controlling a stopping of the motor vehicle if the monitoring has determined that an object is located within the first safety area, in order to stop the motor vehicle, and
controlling a performance of one or several of the following safety actions if the monitoring has determined that an object is located within the second safety area: reducing a current motor vehicle speed, preparing a braking system of the motor vehicle for a braking action, checking the performed monitoring of the second safety area.

According to another aspect of the present invention, a device is provided for reducing a risk of a collision of a driving motor vehicle with an object, including:
a determination device for determining a first safety area, which defines a first delimited subarea of a current surroundings of the driving motor vehicle, and
for determining a second safety area, which defines a second delimited subarea of the current surroundings of the driving motor vehicle, the second subarea being at a greater distance from the motor vehicle than the first subarea,
a monitoring device for monitoring the first and the second subareas for an object moving into the respective safety area and/or for an object located within the respective safety area,
a control unit for controlling a stopping of the motor vehicle if the monitoring has determined that an object is located within the first safety area, in order to stop the motor vehicle, and
for controlling a performance of one or several of the following safety actions if the monitoring has determined that an object is located within the second safety area: reducing a current motor vehicle speed, preparing a braking system of the motor vehicle for a braking action, checking the performed monitoring of the second safety area.

According to another aspect of the present invention, a motor vehicle is provided, which comprises the device of the present invention.

According to another aspect of the present invention, a parking facility for motor vehicles is provided, the parking facility comprising the device of the present invention.

According to yet another aspect of the present invention, a computer program is provided, comprising program code for implementing the method according to the present invention when the computer program is executed on a computer.

The present invention thus includes in particular and inter alia the determining or defining two safety areas in the motor vehicle surroundings, which are respectively monitored. Depending on where a detected object is located, different safety actions are performed. The present invention thus provides for the motor vehicle to be stopped if an object is located within the first safety area. If an object is located within the second safety area, one or several of the following safety actions are performed: reducing a current motor vehicle speed, preparing a braking system of the motor vehicle for a braking action, checking the performed monitoring of the second safety area.

By providing a second safety area, which is at a greater distance than the first safety area, it is advantageously possible to guard against a collision by the safety actions provided in accordance with the present invention. If an object is already located in the first safety area, however, then for safety reasons, the present invention provides for the motor vehicle always to be stopped so as to reduce a collision risk and/or to reduce an accident severity in the event of a collision.

This yields in particular the technical advantage of being able to reduce a collision risk efficiently.

By providing a check of the performed monitoring of the second safety area, it is possible for example to bring about the technical advantage of being able to detect possible errors that occurred during the performed monitoring. This yields in particular the technical advantage that this time the monitoring may be performed specifically with respect to the object.

The provision of reducing a current motor vehicle speed yields in particular the technical advantage of being able efficiently to reduce a collision risk even further. This yields in particular the technical advantage of being able to reduce an accident severity on account of the reduced motor vehicle speed in the event that a collision should occur.

In particular the preparation of the braking system of the motor vehicle for a braking action has in particular the technical advantage of efficiently reducing a reaction time of the braking system when a braking torque is requested. This advantageously shortens a braking distance in an efficient manner.

Another specific embodiment provides for the implementation to comprise a remote control of the one safety action or a remote control of one or several of the several safety actions and/or that the motor vehicle is stopped by remote control.

This yields in particular the technical advantage that it is not necessary for the motor vehicle itself to be designed to decide autonomously which of the safety actions it should perform. For this is done outside of the vehicle, that is, the motor vehicle is remote-controlled. The remote control comprises in particular a transmission of remote control commands to the motor vehicle via a communication network, in response to which the motor vehicle is able to perform and/or performs the one or the multiple safety actions.

Thus, one specific embodiment provides for the motor vehicle to be remote-controlled in such a way that a current motor vehicle speed is reduced. One specific embodiment provides in particular for controlling the motor vehicle remotely in such a way that a braking system of the motor vehicle is prepared for a braking action. One specific embodiment provides in particular for controlling the motor vehicle remotely in such a way that the motor vehicle stops, that is, performs an emergency stop. That is to say that the motor vehicle is stopped by remote control.

Another specific embodiment provides for the monitoring to comprise an analysis of the surroundings data for an object moving into the respective safety area and/or for an object located within the respective safety area, the surroundings data being provided by one or multiple surround sensors that have sensed the respective safety area, the surround sensor(s) being comprised by the motor vehicle and/or being situated in the surroundings of the motor vehicle.

This yields in particular the technical advantage of being able to perform an efficient surroundings analysis of the adapted safety area. If both surround sensors comprised by the motor vehicle as well as surround sensors situated in the surroundings of the motor vehicle are used for the analysis of the surroundings, this yields in particular the technical advantage of achieving a high redundancy.

According to one specific embodiment, the monitoring comprises sensing the respective safety area using one or multiple surround sensors (for example of the motor vehicle and/or of the parking facility) in order to ascertain surroundings data corresponding to the sensed safety area, which are then provided for an analysis of the surroundings.

One specific embodiment provides for the device for reducing a risk of a collision of a motor vehicle with an object to be designed or configured to carry out or implement the method for reducing a risk of a collision of a motor vehicle with an object.

Technical functionalities of the device derive analogously from corresponding technical functionalities of the method and vice versa.

One specific embodiment provides for the method for reducing a risk of a collision of a motor vehicle with an object to be carried out or implemented by the device for reducing a risk of a collision of a motor vehicle with an object.

According to one specific embodiment, the surround sensor is an element or the surround sensors are elements selected from the following group of surround sensors: radar sensor, lidar sensor, laser sensor, video sensor, ultrasonic sensor, magnetic sensor, infrared sensor, light-barrier sensor.

According to one specific embodiment, the device comprises one or more surround sensors.

According to one specific embodiment, the motor vehicle comprises one or more surround sensors.

According to one specific embodiment, the parking facility comprises one or more surround sensors.

According to one specific embodiment, the motor vehicle is designed or configured to carry out or implement the method of the present invention.

According to another specific embodiment, the parking facility is designed or configured to carry out or implement the method of the present invention.

One specific embodiment provides for a communication interface for communication via a communication network. The communication interface is comprised by the motor vehicle for example. The communication interface is comprised by the device for example. The communication interface is comprised by the parking facility for example.

One specific embodiment provides for a detection of an object located within the second safety area to predict a movement of the detected object, the one or the several safety actions being performed only if the prediction has determined that the detected object will approach the motor vehicle and/or will move into the first safety area.

This yields in particular the technical advantage of being able to determine efficiently whether an object located within the second safety area will move into the first safety area.

One specific embodiment provides for a prediction device, which is designed, when an object located within the second safety area is detected, to predict a movement of the detected object, the control unit being designed to perform the one or the several safety actions only if the prediction has determined that the detected object will approach the motor vehicle and/or will move into the first safety area.

Another specific embodiment provides for a third safety area to be determined, which defines a third delimited subarea of the current surroundings of the motor vehicle, the third subarea being at a greater distance from the motor vehicle than the second subarea, the third subarea being monitored for an object moving into the third safety area and/or for an object located within the third safety area, the implementation of the one or of the several safety actions being implemented as a function of the monitoring of the third safety area.

A further specific embodiment provides for the determination device to be designed to determine a third safety area, which defines a third delimited subarea of the current surroundings of the motor vehicle, the third subarea being at a greater distance from the motor vehicle than the second subarea, the monitoring device being designed to monitor the third subarea for an object moving into the third safety area and/or for an object located within the third safety area, the control unit being designed to control the implementation of the one or of the several safety actions as a function of the monitoring of the third safety area.

Providing a third safety area advantageously makes it possible to build up efficiently a cascade of monitored safety areas so as to allow for the concrete safety actions to be controlled to be coordinated and adapted better to the concretely given situation. For example, a motor vehicle speed is reduced in smaller steps if the object triggering the control of the safety action is located in the third safety area compared to the case in which the object is located in the second safety area. It is provided, for example, that a movement of the objects located in the third safety area is predicted.

A further specific embodiment provides for at least one of the determined safety areas (for example the first and/or the second and/or the third safety area) to have different shapes. In particular, all determined safety areas have different shapes.

This yields in particular the technical advantage that, depending on the concrete motor vehicle surroundings, it is possible to cover and monitor the latter efficiently.

The shapes that the determined safety areas may assume are for example the following: round, oval, rectangular, winding or curved. Winding or curved refers to a shape that is adapted to a curve. The curve is a curve that the motor vehicle is to drive through.

That is to say, in particular, that the determination is carried out in such a way that at least one, in particular several or all, of the determined safety areas have different shapes. That is to say, in particular, that the determination device is appropriately designed to determine the safety areas in such a way that at least one of the determined safety areas, in particular all safety areas, have different shapes.

A further specific embodiment provides for one or several of the determined safety areas (for example the first and/or the second and/or the third safety area) to be laid out around the motor vehicle. In particular, all safety areas are laid out around the motor vehicle.

This yields in particular the technical advantage of being able to monitor the surroundings of the motor vehicle efficiently.

That is to say, in particular, that the determination is carried out in such a way that one or several, in particular all, of the determined safety areas are laid out around the motor vehicle. That is to say, in particular, that the determination device is designed to determine the safety areas in such a way that one or several, in particular all, of the determined safety areas are laid out around the motor vehicle.

A parking facility in the sense of the present invention may also be called a parking area and is used as an area for parking motor vehicles. The parking facility thus forms in particular a contiguous area, which has multiple parking spaces (in the case of a parking facility on private property) or parking stalls (in the case of a parking facility on public property). According to one specific embodiment, the parking facility may be developed as a car park. According to one specific embodiment, the parking facility may be developed as a parking garage.

According to one specific embodiment, the motor vehicle drives in driverless fashion. For example, the motor vehicle drives driverlessly within a parking facility.

A driverless travel of the motor vehicle comprises a remote control of the motor vehicle. According to one specific embodiment, a driverless travel of the motor vehicle comprises that the motor vehicle drives autonomously, that is, independently. According to one specific embodiment, an autonomous travel of the motor vehicle provides for the motor vehicle to be at least partially supported, that is, assisted, for this purpose. That is to say that the motor vehicle may be or is assisted in its autonomous travel for example. Such an assistance comprises for example the transmission of travel data to the motor vehicle via a communication network, based on which the motor vehicle is able to drive autonomously. Such data for example include map data of a digital map of the parking facility, setpoint trajectory data of a setpoint trajectory to be driven by the motor vehicle, destination position data of a destination position within the parking facility to which the motor vehicle is to drive.

According to one specific embodiment, the motor vehicle performs an automatic parking process within the parking facility. That is to say that the travel of the motor vehicle is comprised by an automatic parking process. Such an automatic parking process may also be referred to as an AVP process. AVP stands for “automatic valet parking” and may be translated as “automatic parking process”.

In the context of such an AVP process, the motor vehicle drives automatically (remote-controlled or autonomously or a section autonomously and another section in remote-controlled fashion) within a parking facility in order to park in a parking position. That is to say that in the context of an AVP process there is a provision, for example, for the motor vehicle to drive automatically from a drop-off position, at which a driver of the motor vehicle parked the motor vehicle for the performance of an AVP process, to a parking position and parks there automatically. According to one specific embodiment, an AVP process comprises that the motor vehicle drives automatically from a parking position to a pickup position and parks there automatically, where a person is again able to take over the motor vehicle.

In the context of a driverless travel, it is thus no longer necessary for a human driver to be located in the motor vehicle itself in order to drive the motor vehicle.

Objects in the sense of the present invention are for example other motor vehicles, animals, human beings or stationary infrastructure elements.

Another specific embodiment provides for the control unit to be designed to control a remote control of the one safety action or of one or multiple of the multiple safety actions.

Another specific embodiment provides for the monitoring device to be designed to analyze the surroundings data for an object moving into the respective safety area and/or for an object located within the respective safety area, the surroundings data being provided by one or multiple surround sensors that have sensed the respective safety area, the surround sensor(s) being comprised by the motor vehicle and/or being situated in the surroundings of the motor vehicle.

One specific embodiment provides for a respective shape of the safety area or the safety areas to be changed as a function of a current and/or future motor vehicle speed and/or as a function of a current and/or future motor vehicle location.

One specific embodiment provides for the determination device to be designed to change a respective shape of the safety area or the safety areas as a function of a current and/or future motor vehicle speed and/or as a function of a current and/or future motor vehicle location.

The safety areas may thus change dynamically over time or location. This advantageously makes it possible to perform an efficient monitoring of the relevant motor vehicle surroundings.

Features that are described in connection with one of the safety areas apply in particular analogously to the other safety areas.

The present invention is explained below in greater detail with reference to preferred exemplary embodiments.

### BRIEF DESCRIPTION OF THE DRAWINGS

FIG. 1 shows a flow chart of a method for reducing a risk of a collision of a motor vehicle with an object.

FIG. 2 shows a device for reducing a risk of a collision of a motor vehicle with an object.

FIG. 3 shows a motor vehicle.

FIG. 4 shows a parking facility.

FIG. 5 shows the motor vehicle of FIG. 3 while driving within a parking facility.

### DETAILED DESCRIPTION OF EXAMPLE EMBODIMENTS

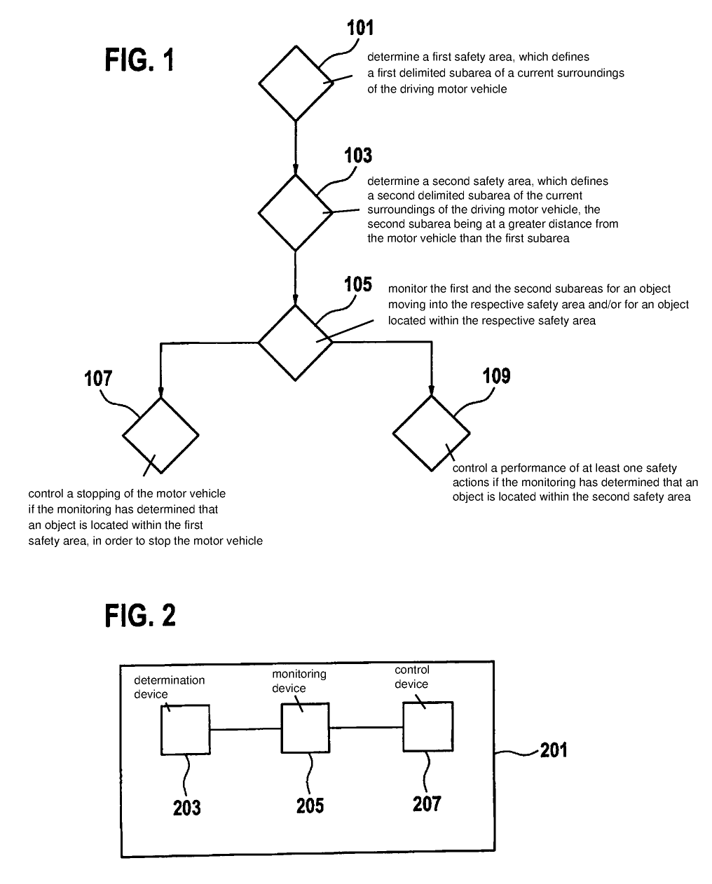

FIG. 1 shows a flow chart of a method for reducing a risk of a collision of a driving motor vehicle with an object.

The method includes the following steps:
determining 101 a first safety area, which defines a first delimited subarea of a current surroundings of the driving motor vehicle,
determining 103 a second safety area, which defines a second delimited subarea of the current surroundings of the driving motor vehicle, the second subarea being at a greater distance from the motor vehicle than the first subarea,
monitoring 105 the first and the second subareas for an object moving into the respective safety area and/or for an object located within the respective safety area,
controlling 107 a stopping of the motor vehicle if the monitoring has determined that an object is located within the first safety area, in order to stop the motor vehicle, and
controlling 109 a performance of one or several of the following safety actions if the monitoring has determined that an object is located within the second safety area: reducing a current motor vehicle speed, preparing a braking system of the motor vehicle for a braking action, checking the performed monitoring of the second safety area.

FIG. 2 shows a device 201 for reducing a risk of a collision of a driving motor vehicle with an object.

Device 201 includes:
a determination device 203 for determining a first safety area, which defines a first delimited subarea of a current surroundings of the driving motor vehicle, and
for determining a second safety area, which defines a second delimited subarea of the current surroundings of the driving motor vehicle, the second subarea being at a greater distance from the motor vehicle than the first subarea,
a monitoring device 205 for monitoring the first and the second subareas for an object moving into the respective safety area and/or for an object located within the respective safety area,
a control unit 207 for controlling a stopping of the motor vehicle if the monitoring has determined that an object is located within the first safety area, in order to stop the motor vehicle, and
for controlling a performance of one or several of the following safety actions if the monitoring has determined that an object is located within the second safety area: reducing a current motor vehicle speed, preparing a braking system of the motor vehicle for a braking action, checking the performed monitoring of the second safety area.

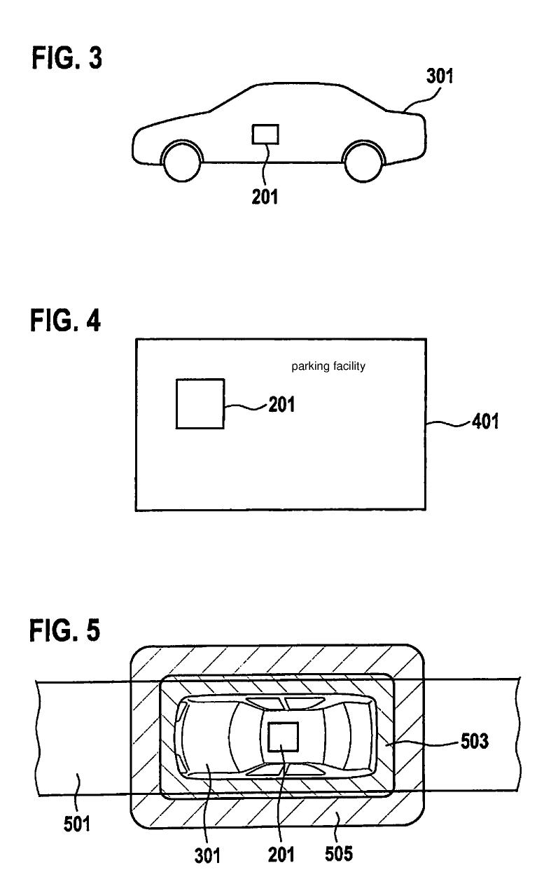

FIG. 3 shows a motor vehicle 301 including device 201 of FIG. 2. For the sake of clarity, elements 203, 205, 207 are not shown.

Motor vehicle 301 includes for example one or multiple surround sensors. Motor vehicle 301 includes for example a communication interface for communicating via a communication network. Via the communication interface, vehicle 301 is able to receive remote control commands, for example.

FIG. 4 shows a parking facility 401 for motor vehicles.

Parking facility 401 includes the device 201 from FIG. 2. For the sake of clarity, elements 203, 205, 207 are not shown.

According to one specific embodiment, parking facility 401 includes one or more surround sensors. According to one specific embodiment, parking facility 401 includes a communication interface for communicating via a communication network. Via the communication interface, it is possible for example to transmit remote control commands to a motor vehicle.

One specific embodiment provides for a parking facility management system that is designed to control an operation of the parking facility. The parking facility management system comprises for example device 201. The parking facility management system controls an AVP process for a motor vehicle, for example.

FIG. 5 show motor vehicle 301 from FIG. 3 while driving in a lane 501. Lane 501 is comprised by a parking facility (not shown in detail). For example, lane 501 is comprised by parking facility 401 from FIG. 4.

Determination device 203 determines two safety areas: a first safety area 503 and a second safety area 505, which respectively define a delimited subarea of the current surroundings of motor vehicle 301. Second safety area 505 is located at a greater distance from motor vehicle 301 than first safety area 503.

Both safety areas 503, 505 are determined in such a way that they are laid out around motor vehicle 301. That is to say that the two safety areas 503, 505 encircle or enclose motor vehicle 301.

In the configuration shown in FIG. 5, both safety areas 503, 505 have a rectangular design. That is to say that the two safety areas 503, 505 respectively have a rectangular shape.

Further exemplary embodiment, which are not shown, provide for first safety area 503 and/or second safety area 505 to have an oval shape and/or a circular shape. According to another specific embodiment, which is not shown, a respective shape of the two safety areas 503, 505 differs.

According to one specific embodiment, the determination of the first and/or second safety area 503, 505 comprises that these safety areas 503, 505 are adapted to a setpoint trajectory to be traveled by motor vehicle 301. One specific embodiment provides for the two safety areas 503, 505 to run parallel or not parallel to each other. Another specific embodiment provides for the first safety area 503 to be rectangular, the second safety area 505 being directed toward the setpoint trajectory to be traveled by motor vehicle 301.

The two safety areas 503, 505 are monitored, as described above, by one or more surround sensors. In this case there is a provision, for example, for the surround sensors of motor vehicle 301 to monitor the two areas 503, 505. That is to say that these surround sensors sense the two safety areas 503, 505 and ascertain surroundings data corresponding to the sensing operation. These surroundings data are then subjected to a surroundings analysis.

Analogously, that is, in particular additionally or alternatively, the monitoring is performed by one or multiple surround sensors which are comprised by the parking facility, that is, which are situated generally within the parking facility.

One specific embodiment provides that the two safety areas are on the one hand determined and monitored accordingly in the motor vehicle itself. At the same time, this specific embodiment provides for the safety areas to be determined and monitored also outside of the vehicle by a corresponding device of the parking facility. The results of the two monitoring processes are then used according to one specific embodiment to control the implementation of the one or the several safety actions. According to one specific embodiment, the control unit is designed to use results of a vehicle-internal and of a vehicle-external monitoring process to control the implementation of the one or multiple safety actions.

In summary, the present invention provides in particular an efficient technical solution, based on which it is possible efficiently to reduce a risk of a collision of a motor vehicle with an object.

According to the present invention, a check is performed by way of multiple dynamic safety areas as to whether an object (motor vehicle, human being, animal) is approaching the motor vehicle and/or is present in its driving path and/or is moving into its driving path. That is to say that the present invention provides for the determination or definition of at least two safety areas, in particular three or more safety areas, which are scanned or sensed or monitored for example by a surround sensor or by multiple surround sensors.

With reference to FIG. 5, the present invention provides for example for the second safety area 505 to be monitored as to whether an object approaches motor vehicle 301. Thereupon, a check is performed for example to determine whether this object has already come too close (has undershot a specified minimum distance) and/or whether it will continue to move into the driving path of the motor vehicle (prediction). The present invention furthermore provides for one or several of the following preventative measures (safety actions) to be initiated and performed:
a motor vehicle speed is reduced,
a braking system of the motor vehicle is prepared for a braking action,
a surroundings analysis is triggered once more (rechecking, that is, checking once more the monitoring of the second safety area 505. The latter measure is performed with specific reference to the detected object, it being possible to focus on the object, for example. It is possible, for example, to use another surroundings model for the surroundings analysis).

If the object is already in the first safety area 503, then an emergency stop is immediately initiated for safety due to the proximity of the object to motor vehicle 301, that is, the motor vehicle is stopped.

The present invention is adaptable in particular to more than two safety areas and is also thus provided for more than two safety areas.

The shape of the safety areas is rectangular, for example. The shape is for example a round or oval shape. The respective shapes of the safety areas are adapted for example, analogously to the adaptive high headlight beam or adaptive low headlight beam, to a setpoint trajectory to be traveled by the motor vehicle.

In another specific embodiment, the shapes of the safety areas differ from one another. These run for example no longer at least partially parallel to one another. For example, the first safety area is situated rectangularly around the vehicle, the second safety area being oriented for example toward a setpoint trajectory to be traveled by the motor vehicle.

According to one specific embodiment, the safety areas are monitored by one or multiple surround sensors. In particular, multiple surround sensors are used, as may be comprised by sensor systems, for example. The surround sensors are either all comprised by the motor vehicle or all comprised by the parking facility (comprised by a parking facility management monitoring infrastructure) or are comprised both by the motor vehicle as well as by the parking facility management monitoring infrastructure.

One specific embodiment also provides for the device of the motor vehicle and for the device of the parking facility to determine and monitor corresponding first and second safety areas separately of one another.

1-17. (canceled)

18. A method for reducing a risk of a collision of a driving motor vehicle with an object, comprising:
determining a first safety area, which defines a first delimited subarea of a current surroundings of the driving motor vehicle;
determining a second safety area, which defines a second delimited subarea of the current surroundings of the driving motor vehicle, the second subarea being at a greater distance from the motor vehicle than the first subarea;
monitoring the first subarea and the second subarea for at least one of: (i) an object moving into the respective safety area, and (ii) an object located within the respective safety area;
controlling a stoppage of the motor vehicle if the monitoring has determined that an object is located within the first safety area, to stop the motor vehicle; and
controlling a performance of at least one of the following safety actions if the monitoring has determined that an object is located within the second safety area: reducing a current motor vehicle speed, preparing a braking system of the motor vehicle for a braking action, and checking the performed monitoring of the second safety area.

19. The method as recited in claim 18, wherein in a detection of an object located within the second safety area, a movement of the detected object is predicted, the at least one safety action being performed only if the prediction has determined that the detected object will at least one of: (i) approach the motor vehicle, and (ii) move into the first safety area.

20. The method as recited in claim 18, wherein a third safety area is determined, which defines a third delimited subarea of the current surroundings of the motor vehicle, the third subarea being at a greater distance from the motor vehicle than the second subarea, the third subarea being monitored for at least one of: (i) an object moving into the third safety area, and (ii) an object located within the third safety area, the implementation of the at least one safety action being carried out as a function of the monitoring of the third safety area.

21. The method as recited in claim 18, wherein at least one of the determined safety areas has different shapes.

22. The method as recited in claim 18, wherein at least some of the determined safety areas are laid out around the motor vehicle.

23. The method as recited in claim 18, wherein a respective shape of the safety areas is changed as at least one of: (i) a function of a current motor vehicle speed, (ii) a function of a future motor vehicle speed, (iii) a function of a current motor vehicle location, and (iv) a function of a future motor vehicle location.

24. The method as recited in claim 18, wherein the safety areas are determined and monitored accordingly in the motor vehicle itself, the safety areas being also determined and monitored outside of the vehicle, results of the monitoring in the motor vehicle and the monitoring outside of the vehicle being used to control implementation of the at least one safety action.

25. A device for reducing a risk of a collision of a driving motor vehicle with an object, comprising:
a determination device configured to determine a first safety area, which defines a first delimited subarea of a current surroundings of the driving motor vehicle, and to determine a second safety area, which defines a second delimited subarea of the current surroundings of the driving motor vehicle, the second subarea being at a greater distance from the motor vehicle than the first subarea;
a monitoring device configured to monitor each respect subarea of the first and the second subareas at least one of: (i) for an object moving into the respective safety area, and for an object located within the respective safety area; and
a control unit configured to control a stoppage of the motor vehicle if the monitoring has determined that an object is located within the first safety area, in order to stop the motor vehicle, and to control a performance of at least one of the following safety actions if the monitoring has determined that an object is located within the second safety area: reducing a current motor vehicle speed, preparing a braking system of the motor vehicle for a braking action, and checking the monitoring of the second safety area.

26. The device as recited in claim 25, further comprising:
a prediction device which is designed, when detecting an object located within the second safety area, to predict a movement of the detected object, wherein the control unit is designed to perform the at least one safety action only if the prediction has determined that the detected object will at least one of: (i) approach the motor vehicle, and (ii) move into the first safety area.

27. The device as recited in claim 25, wherein the determination device is designed to determine a third safety area, which defines a third delimited subarea of the current surroundings of the motor vehicle, the third subarea being at a greater distance from the motor vehicle than the second subarea, the monitoring device being designed to monitor the third subarea for at least one of: (i) an object moving into the third safety area, and (ii) an object located within the third safety area, the control unit being designed to control implementation of the at least one safety action as a function of the monitoring of the third safety area.

28. The device as recited in claim 25, wherein at least one of the determined safety areas has different shapes.

29. The device as recited in claim 25, wherein at least some of the determined safety areas are laid out around the motor vehicle.

30. The device as recited in claim 25, wherein the determination device is designed to change a respective shape of the safety areas as a function of at least one of a current motor vehicle speed, a future motor vehicle speed, a current motor vehicle location, and a future motor vehicle location.

31. The device as recited in claim 25, wherein the control unit is designed to use results of a vehicle-internal and of a vehicle-external monitoring process to control implementation of the at least one safety action.

32. A motor vehicle, comprising:
a device for reducing a risk of a collision of a driving motor vehicle with an object, the device including a determination device configured to determine a first safety area, which defines a first delimited subarea of a current surroundings of the driving motor vehicle, and to determine a second safety area, which defines a second delimited subarea of the current surroundings of the driving motor vehicle, the second subarea being at a greater distance from the motor vehicle than the first subarea, a monitoring device configured to monitor each respect subarea of the first and the second subareas at least one of: (i) for an object moving into the respective safety area, and for an object located within the respective safety area, and a control unit configured to control a stoppage of the motor vehicle if the monitoring has determined that an object is located within the first safety area, in order to stop the motor vehicle, and to control a performance of at least one of the following safety actions if the monitoring has determined that an object is located within the second safety area: reducing a current motor vehicle speed, preparing a braking system of the motor vehicle for a braking action, and checking the monitoring of the second safety area.

33. A parking facility for motor vehicles, comprising:
a device for reducing a risk of a collision of a driving motor vehicle with an object, the device including a determination device configured to determine a first safety area, which defines a first delimited subarea of a current surroundings of the driving motor vehicle, and to determine a second safety area, which defines a second delimited subarea of the current surroundings of the driving motor vehicle, the second subarea being at a greater distance from the motor vehicle than the first subarea, a monitoring device configured to monitor each respect subarea of the first and the second subareas at least one of: (i) for an object moving into the respective safety area, and for an object located within the respective safety area, and a control unit configured to control a stoppage of the motor vehicle if the monitoring has determined that an object is located within the first safety area, in order to stop the motor vehicle, and to control a performance of at least one of the following safety actions if the monitoring has determined that an object is located within the second safety area: reducing a current motor vehicle speed, preparing a braking system of the motor vehicle for a braking action, and checking the monitoring of the second safety area.

34. A non-transitory computer readable storage medium on which is stored a computer program including program code for reducing a risk of a collision of a driving motor vehicle with an object, the computer program, when executed by a computer, causing the computer to perform:
determining a first safety area, which defines a first delimited subarea of a current surroundings of the driving motor vehicle;
determining a second safety area, which defines a second delimited subarea of the current surroundings of the driving motor vehicle, the second subarea being at a greater distance from the motor vehicle than the first subarea;
monitoring each respective safety area of the first and the second subareas at least one of: (i) for an object moving into the respective safety area, and (ii) for an object located within the respective safety area;
controlling a stoppage of the motor vehicle if the monitoring has determined that an object is located within the first safety area, in order to stop the motor vehicle; and
controlling a performance of at least one of the following safety actions if the monitoring has determined that an object is located within the second safety area: reducing a current motor vehicle speed, preparing a braking system of the motor vehicle for a braking action, and checking the performed monitoring of the second safety area.
